(19) United States
(12) Patent Application Publication
(10) Pub. No.: US 2019/0293820 A1
(43) Pub. Date: Sep. 26, 2019

(54) Multi-Stage Noise Attenuation for Marine Seismic Survey Data

(71) Applicant: PGS Geophysical AS, Oslo (NO)

(72) Inventor: Truong Nguyen, Weybridge (GB)

(73) Assignee: PGS Geophysical AS, Oslo (NO)

(21) Appl. No.: 16/364,778

(22) Filed: Mar. 26, 2019

Related U.S. Application Data
(60) Provisional application No. 62/748,848, filed on Oct. 22, 2018.
(60) Provisional application No. 62/648,127, filed on Mar. 26, 2018.

(51) Int. Cl. G01V 1/38

(52) U.S. Cl. CPC G01V 1/38; G01V 2210/584; G01V 2210/324; G01V 2210/64; G01V 2210/40

(57) ABSTRACT

Noise signals can be attenuated on a trace-by-trace basis from traces of marine seismic survey data to yield a signal component and a noise component. A signal-to-noise ratio (SNR) variance of a plurality of traces comprising the signal component can be less than an SNR variance of the plurality of traces comprising the marine seismic survey data. Signal leakage can be attenuated from the noise component to yield a signal leakage component. A seismic image of a subsurface location can be generated based on the signal component and the signal leakage component.

### CROSS-REFERENCE TO RELATED APPLICATIONS

This application claims priority to U.S. Provisional Application 62/648,127, filed Mar. 26, 2018, and US. Provisional Application 62/748,848, filed Oct. 22, 2018, which are incorporated by reference as if entirely set forth herein.

### BACKGROUND

In the past few decades, the petroleum industry has invested heavily in the development of marine survey techniques that yield knowledge of subterranean formations beneath a body of water in order to find and extract valuable resources, such as oil. High-resolution images of a subterranean formation are helpful for quantitative interpretation and improved reservoir monitoring. For a typical marine survey, a marine survey vessel tows one or more marine survey sources (hereinafter referred to as “sources”) below the sea surface and over a subterranean formation to be surveyed. Marine survey receivers (hereinafter referred to as “receivers”) may be located on or near the seafloor, on one or more streamers towed by the marine survey vessel, or on one or more streamers towed by another vessel. The marine survey vessel typically contains marine survey equipment, such as navigation control, source control, receiver control, and recording equipment. The source control may cause the one or more marine survey sources, which can be impulsive sources such as air guns, non-impulsive sources such as marine vibrator sources, electromagnetic sources, etc., to produce signals at selected times. Each signal is essentially a wave that travels down through the water and into the subterranean formation. At each interface between different types of rock, a portion of the wave may be refracted, and another portion may be reflected, which may include some scattering, back toward the body of water to propagate toward the sea surface. The receivers thereby measure a wave that was initiated by the actuation of the marine survey source.

### BRIEF DESCRIPTION OF THE DRAWINGS

FIG. 1 is an elevation or xz-plane view of marine surveying in which signals are emitted by a marine survey source for recording by receivers.

FIG. 2 is a block diagram representation of an exemplary embodiment of multi-stage noise attenuation.

FIG. 3 is an example of a time-frequency plane corresponding to a trace.

FIG. 4 is an example of marine seismic survey data prior to multi-stage noise attenuation.

FIG. 5A is an example of a signal component from a first stage of multi-stage noise attenuation.

FIG. 5B is an example of a noise component from a first stage of multi-stage noise attenuation.

FIG. 6A is an example of a signal component having a signal leakage component added thereto following a second stage of multi-stage noise attenuation.

FIG. 6B is an example of a noise component of having a signal leakage component attenuated therefrom following a second stage of multi-stage noise attenuation.

FIG. 7A is an example of marine seismic survey data from an outer streamer of a marine seismic survey in a deep water environment.

FIG. 7B is an example of denoised marine seismic survey data after multi-stage noise attenuation.

FIG. 7C is an example of a noise component in marine seismic survey data obtained from multi-stage noise attenuation.

FIG. 8A is an example of a stack of velocity sensor shot gathers.

FIG. 8B is an example of a stack of velocity sensor shot gathers after a previous approach to noise attenuation.

FIG. 8C is an example of a stack of velocity sensor shot gathers after multi-stage noise attenuation.

FIG. 9 is a graph illustrating spectral comparisons.

FIG. 10 is an exemplary embodiment of a method for multi-stage noise attenuation.

FIG. 11 is an exemplary embodiment of a machine-readable medium for multi-stage noise attenuation.

FIG. 12 is a diagram illustrating an exemplary embodiment of a system for multi-stage noise attenuation.

FIG. 13 is a diagram of an exemplary embodiment of a machine for multi-stage noise attenuation.

### DETAILED DESCRIPTION

The present disclosure is related to attenuating noise, such as barnacle noise, in marine seismic survey data using a multi-stage approach. For example, in a first stage, noise signals in the marine seismic survey data can be attenuated and in a second stage, signal leakage resulting from the first stage can be recovered. Embodiments of present disclosure can include time-frequency (TF) transforms and enable user-customized control of noise removal and signal leakage. The TF transforms can be self-invertible transforms, which may also be referred to as tight frame; however, embodiments of the present disclosure are not so limited.

Marine seismic survey data recorded by one or more receivers can include data corresponding to one or more physical signals, including seismic signals and noise signals. A seismic signal can result from an actuation of a marine survey source whereas a noise signal can result from a noise source other than an actuation of a marine survey source. Examples of noise sources include, but are not limited to, barnacles on a streamer, position control devices, such as “e-birds,” on a streamer, and environmental effects such as ocean swells and weather. One or more seismic signals can be intermingled with one or more noise signals in the marine seismic survey data. As used herein, the term “noisy seismic data” refers to data corresponding to one or more seismic signals that is intermingled with data corresponding to one or more noise signals.

Marine seismic survey data can be made up of traces, where each trace includes one or more seismic signals recorded by a single receiver. A trace can also include one or more noise signals. Although the trace may be recorded digitally, the name “trace” comes from the curve plotted by a seismograph as a paper roll rotated and a needle left a trace on the paper. As used herein, a trace includes at least one seismic signal, but may not necessarily include a noise signal. As used herein, “noisy traces” refer to traces of marine seismic survey data that include at least one noise signal from a particular noise source or to traces having less than a threshold signal-to-noise ratio (SNR). As used herein, “non-noisy traces” refers to traces that do not include a noise signal from the particular noise source or to traces having greater than a threshold SNR.

A gather is a display of traces that share a common acquisition parameter, such as a common midpoint, a common receiver, a common offset, etc. A shot gather is a gather of traces that share a common source location. In a two-dimensional (2-D) shot gather, each trace is a one-dimensional (1-D) signal from a sensor receiving an arriving wave.

Noise signals in marine seismic survey data can be incoherent from trace to trace. In contrast, seismic signals in marine seismic survey data can be coherent across traces. The coherency of seismic signals from trace to trace can be used to preserve the seismic signals during denoising. Noise signals in marine seismic survey data can be reduced or removed before applying other processing steps to the marine seismic survey data. Some previous approaches for removal of noise signals may be directly applied to marine seismic survey data because of how the marine seismic survey data is acquired. Noise signals associated with a receiver can have characteristics that vary significantly from trace to trace including, for instance, different types of noise, such as barnacle noise, bird noise, swell noise, and weather-related noise. As a result, traces acquired from one or more streamers may have SNRs that vary significantly from trace to trace. At least one embodiment of the present disclosure takes this information into account resulting in improved noise attenuation with fewer parameters than previous approaches, increased turnaround time, and improved acquisition efficiency.

At least one embodiment of the present disclosure includes attenuating noise signals in marine seismic survey data in three stages. In a preprocessing stage, marine seismic survey data can be prepared for subsequent stages. Physical characteristics of a type of noise (for example, barnacle noise) to be attenuated can be used to prepare marine seismic survey data for noise attenuation performed in subsequent stages. Information about the noise obtained from the preprocessing stage can be used in subsequent stages. In the next stage, noise signals can be attenuated from noisy traces on a trace-by-trace basis to yield a signal component having approximately the same SNR across traces and a noise component. As used herein, “attenuating noise on a trace-by-trace basis” refers to attenuating noise signals in each trace individually, but does not necessarily mean that each trace is denoised independently. Independent denoising of traces would mean that a trace is denoised without regard to the denoising of other traces. Noise signals can be adaptively attenuated using one or more relative parameters. In the last stage, signal leakage in the noise component can be attenuated. An estimation of a coherent seismic signal in the noise component can be used to attenuate signal leakage in the noise component.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected and, unless stated otherwise, can include a wireless connection.

The figures herein follow a numbering convention in which the first digit or digits correspond to the drawing figure number and the remaining digits identify an element or component in the drawing. Similar elements or components between different figures may be identified by the use of similar digits. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

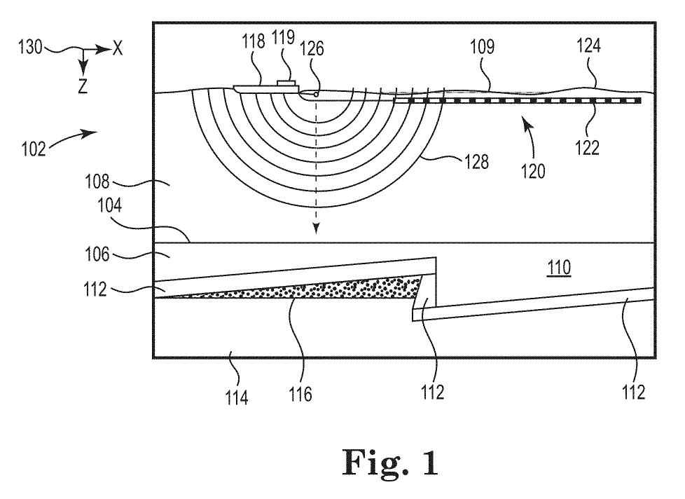

FIG. 1 is an elevation or xz-plane 130 view of marine surveying in which signals are emitted by a marine survey source 126, such as a non-impulsive source, for recording by receivers 122. The recording can be used for processing and analysis in order to help characterize the structures and distributions of features and materials underlying the surface of the earth. For example, the recording can be used to estimate a physical property of a subsurface location, such as the presence of a reservoir that may contain hydrocarbons. FIG. 1 shows a domain volume 102 of the earth's surface comprising a subsurface volume 106 of sediment and rock below the surface 104 of the earth that, in turn, underlies a fluid volume 108 of water having a sea surface 109 such as in an ocean, an inlet or bay, or a large freshwater lake. The domain volume 102 shown in FIG. 1 represents an example experimental domain for a class of marine surveys. FIG. 1 illustrates a first sediment layer 110, an uplifted rock layer 112, an underlying rock layer 114, and a hydrocarbon-saturated layer 116. One or more elements of the subsurface volume 106, such as the first sediment layer 110 and the uplifted rock layer 112, can be an overburden for the hydrocarbon-saturated layer 116. In some instances, the overburden may include salt.

FIG. 1 shows an example of a marine survey vessel 118 equipped to carry out marine surveys. In particular, the marine survey vessel 118 can tow one or more streamers 120 (shown as one streamer for ease of illustration) generally located below the sea surface 109. The streamers 120 can be long cables containing power and data-transmission lines (e.g., electrical, optical fiber, etc.) to which receivers may be coupled. In one type of marine survey, each receiver, such as the receiver 122 represented by the shaded disk in FIG. 1, comprises a pair of sensors including a geophone that detects particle displacement within the water by detecting particle motion variation, such as velocities or accelerations, and/or a receiver that detects variations in pressure.

The streamers 120 and the marine survey vessel 118 can include sensing electronics and data-processing facilities that allow receiver readings to be correlated with absolute positions on the sea surface and absolute three-dimensional positions with respect to a three-dimensional coordinate system. In FIG. 1, the receivers along the streamers 120 are shown to lie below the sea surface 109, with the receiver positions correlated with overlying surface positions, such as a surface position 124 correlated with the position of receiver 122.

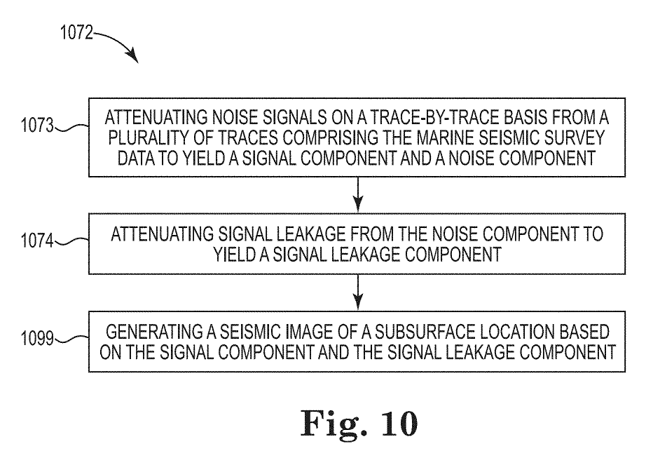

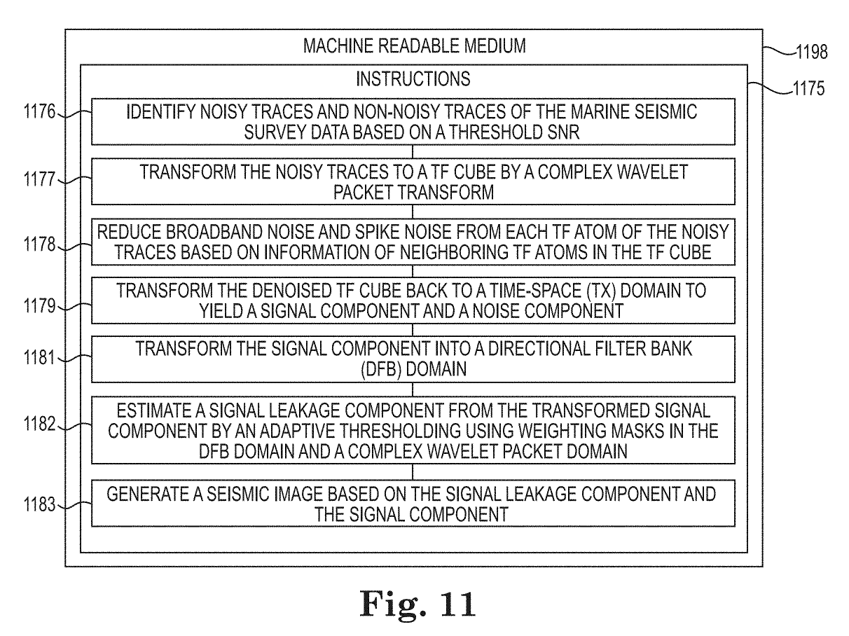

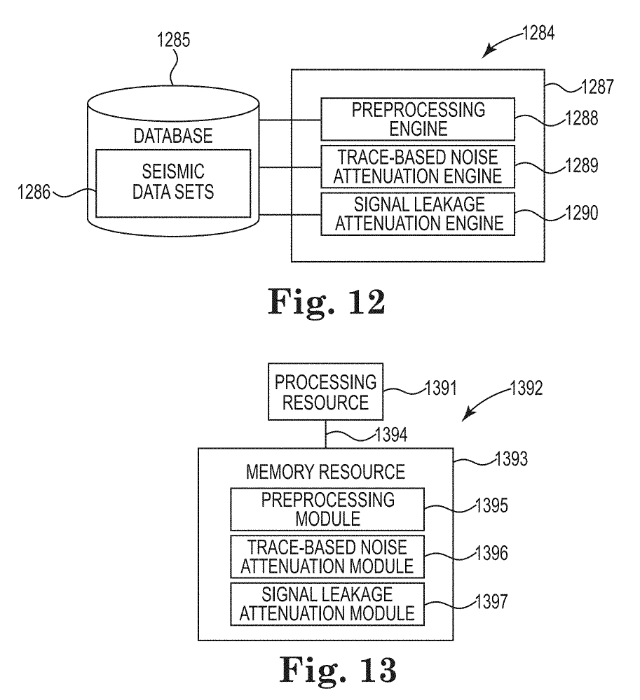

The marine survey vessel 118 can tow one or more marine survey sources 126 that produce signals as the marine survey vessel 118 and streamers 120 move across the sea surface 109. The marine survey sources 126 and/or streamers 120 may also be towed by other vessels or may be otherwise disposed in fluid volume 108. For example, the receivers may be located on ocean bottom cables or nodes fixed at or near the surface 104, and the marine survey sources 126 may also be disposed in a nearly-fixed or fixed configuration. For the sake of efficiency, illustrations and descriptions herein show receivers located on streamers, but it should be understood that references to receivers located on a “streamer” or “cable” should be read to refer equally to receivers located on a towed streamer, an ocean bottom receiver cable, and/or an array of nodes. Although illustrated as a point, the marine survey source 126 can represent a source string or a marine survey source array. The marine survey vessel 118 can include a controller 119. For example, the controller 119 can be coupled to the receivers 122 and configured to receive seismic survey data from the receivers 122. The controller 119 can be configured to perform some or all of the functions associated with the method illustrated in FIG. 10. The controller 119 can store the machine-readable medium 1175 illustrated in FIG. 11. The controller 119 can implement some or all of the system 1284 illustrated in FIG. 12. The controller 119 can be configured to perform some or all of the machine 1392 illustrated in FIG. 13. However, embodiments of the present disclosure are not limited to being performed onboard a marine survey vessel. For example, at least one embodiment can be performed by a system, such as the system 1284, or a machine, such as the machine 1392, onshore.

FIG. 1 shows acoustic energy illustrated as an expanding, spherical signal, illustrated as semicircles of increasing radius centered at the marine survey source 126, representing a down-going wavefield 128, following a signal emitted by the marine survey source 126. A wavefield refers to the extended area or space taken up by a wave. For ease of illustration and consideration with respect to the detail shown in FIG. 1, the down-going wavefield 128 may be considered as a combined output of an array of non-impulsive sources. The down-going wavefield 128 is, in effect, shown in a vertical plane cross section in FIG. 1. The outward and downward expanding down-going wavefield 128 may eventually reach the surface 104, at which point the outward and downward expanding down-going wavefield 128 may partially scatter, may partially reflect back toward the streamers 120, and may partially refract downward into the subsurface volume 106, becoming elastic signals within the subsurface volume 106. Receivers 122 can measure portions of the wavefield 128 directly from the marine survey source 126, reflecting off of the sea surface 109, returning from the surface 104, and returning from the subsurface volume 106.

Barnacles can attach themselves to streamers (for example, the streamers 120). Barnacles can grow rapidly. Removing barnacles from streamers may not be possible due to time constraints or sea conditions. Barnacles near receivers can be a source of noise in marine seismic survey data from those receivers. Velocity sensors (for example, geophones) can be particularly susceptible to barnacle noise, even with little growth of barnacles. Some previous approaches to reducing noise signals resulting from barnacles may include physical methods such as painting streamers with a special coating to reduce growth of barnacles and removing barnacles from streamers. However, such physical methods may require a marine survey to be paused or stopped, for example, to retrieve and redeploy the streamers.

Some previous approaches to reducing noise from barnacles in marine seismic survey data may include mitigating effects of barnacles on marine seismic survey data. However, removing noise signals, such as those corresponding to barnacle noise, from marine seismic survey data can alter a seismic signal in the marine seismic survey data. The noise signals can be incoherent and affect a plurality of traces such that the noise signals are in the same frequency band as the seismic signal. The noise variance can be relatively consistent throughout a trace (throughout the length of the recording), but inconsistent from trace to trace. Because barnacles may grow during acquisition of marine seismic survey data (a marine survey can be performed over the course of several days or weeks), traces in the marine seismic survey data may become progressively noisier and the quality of the marine seismic survey data may degrade progressively.

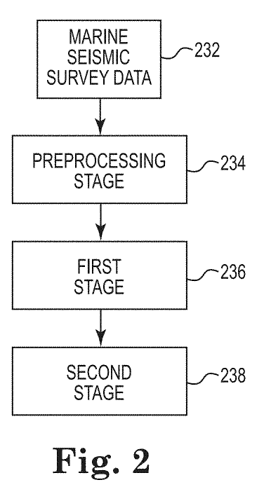

FIG. 2 is a block diagram representation of an exemplary embodiment of multi-stage noise attenuation for marine seismic survey data 232. In at least one embodiment, multi-stage noise attenuation can include a preprocessing stage 234, a first stage 236, and a second stage 238. The marine seismic survey data 232 can include a plurality of traces. Each trace can correspond to a particular receiver or a particular sensor of a receiver, such as the receiver 122 of the streamer 120 illustrated in FIG. 1. For example, a streamer including fifty receivers can have a corresponding fifty traces of marine seismic survey data. In some embodiments, multi-sensor receivers can have more than one trace per receiver. The marine seismic survey data 232 can be acquired from a shot gather, for example.

In the preprocessing stage 234, the marine seismic survey data 232 can be prepared for attenuation of a particular type of noise (noise from a particular type of noise source) from the marine seismic survey data 232 during the first stage 236 and the second stage 238. Noisy traces of the marine seismic survey data 232 can be distinguished from non-noisy traces of the marine seismic survey data 232. For example, traces including noise signals from barnacles can be classified as noisy and traces not including noise signals from barnacles noise can be classified as non-noisy. Attributes, such as energy or frequencies, of a trace can be subtracted from the trace based on physical characteristics of a particular type of noise.

For example, barnacle noise can have frequency content that is under one hundred Hertz (Hz) and seismic signals can have frequency content that is under two hundred and fifty Hz. In the preprocessing stage 234, traces of marine seismic survey data 232 can be transformed to a frequency domain, for example, by a fast Fourier transform (FFT) in order to address the frequency-based differences of the marine seismic survey data. Portions of the marine seismic survey data 232 that exceed a threshold frequency (residual seismic data including seismic signals) can be filtered to yield noisy seismic data (seismic data including seismic signals and noise signals). For example, the transformed traces can be multiplied with a window such that amplitudes of the traces are zero above the threshold frequency. In this example, the threshold frequency can be one hundred Hz to exclude seismic signal content that is greater than one hundred Hz. An inverse FFT can be applied to the yielded noisy seismic data to return it from the frequency domain to an original domain of the marine seismic survey data 232, such as a time-space (TX) domain. This process may be referred to as downsampling because fewer frequencies are “sampled.” The process may also be referred to as downsampling without information loss because, as opposed to more traditional downsampling, the process is lossless versus lossy.

In at least one embodiment, the preprocessing stage 234 can include classifying traces of the marine seismic survey data 232 or the noisy seismic data that was filtered from the marine seismic survey data 232 as noisy or non-noisy. A trace can be classified as a noisy if an SNR of the trace is below a threshold SNR. Conversely, a trace can be classified as non-noisy if an SNR of the trace is at or above a threshold SNR. The threshold value can be a user-defined parameter, a non-limiting example of which is ten decibels. A noisy trace as defined above can be classified as non-noisy if the SNR of the noisy trace is at or above the threshold SNR despite the noisy trace including a noise signal.

In at least one embodiment, the preprocessing stage 234 can include extracting attributes from each trace of the marine seismic survey data 232 or the noisy seismic data and using clustering methods or feature extraction and machine learning to classify traces of the marine seismic survey data 232 or the noisy seismic data as noisy or non-noisy.

Because of the preprocessing stage 234, the residual seismic data can be excluded from the noise attenuation performed in the first stage 236 and the second stage 238. Non-noisy traces of the marine seismic survey data 232 or the noisy seismic data can be excluded as well from the noise attenuation performed in the first stage 236 and the second stage 238. However, as explained herein, traces classified as non-noisy may still be used in the first stage 236 or the second stage 236 even though the noise attenuation may not be performed on the non-noisy traces. As a result, the noise attenuation performed in the first stage 236 and the second stage 238 can be better focused on the yielded noisy seismic data and not unnecessarily performed on the residual seismic data and can leave traces classified as non-noisy unaffected by the noise attenuation. Thus, the preprocessing stage 234 can reduce the complexity of attenuating noise from the marine seismic survey data 232.

The noisy seismic data from the preprocessing stage 234 can be an input of the first stage 236 of multi-stage noise attenuation. The first stage 236 can include performing noise attenuation on a trace-by-trace basis on the noisy seismic data (or the marine seismic survey data 232 directly in embodiments that do not include the preprocessing stage 234). The first stage 236 can include performing noise attenuation on traces of the noisy seismic data or the marine seismic survey data 232 that have been classified as noisy. The dimension of a trace is time. Although a trace can be represented by a 2-D graph with time on one axis and amplitude on another, time is the sole dimension. Thus, performing noise attenuation on a trace-by-trace basis can be noise attenuation performed in one dimension.

Performing noise attenuation on a trace-by-trace basis can include applying a 1-D TF transform to noisy traces of the marine seismic survey data 232 or the noisy seismic data. For example, a 1-D TF transform can be applied on a trace-by-trace basis to the noisy seismic data generated during the preprocessing stage 234. A non-limiting example of a 1-D TF transform is a 1-D complex wavelet transform. A 1-D complex wavelet transform is a low-redundancy TF transform that can be implemented using finite impulse response (FIR) filters. In at least one embodiment of the present disclosure, a 1-D complex wavelet transform can be implemented using FIR filters only. A FIR filter is a filter whose impulse response (or response to any finite length input) is of finite duration, because the impulse response settles to zero in a finite amount of time. Other examples of 1-D TF transforms include, but are not limited to, a TF Gabor transform or a short-time Fourier transform. Applying a 1-D TF transform to traces enables each trace to be represented as a 2-D TF plane. The two dimensions of a TF plane can be time and frequency. A TF plane can include a plurality of TF atoms. As used herein, a TF atom refers to a pair of a frequency value and a time value of a trace and represents an amplitude of the trace at the frequency and time values. Seismic signals can have a sparse representation in the TF domain. Thus, a seismic signal of interest can be represented by a few TF atoms. In contrast to seismic signals, noise, such as broadband barnacle noise, can be represented by many TF atoms.

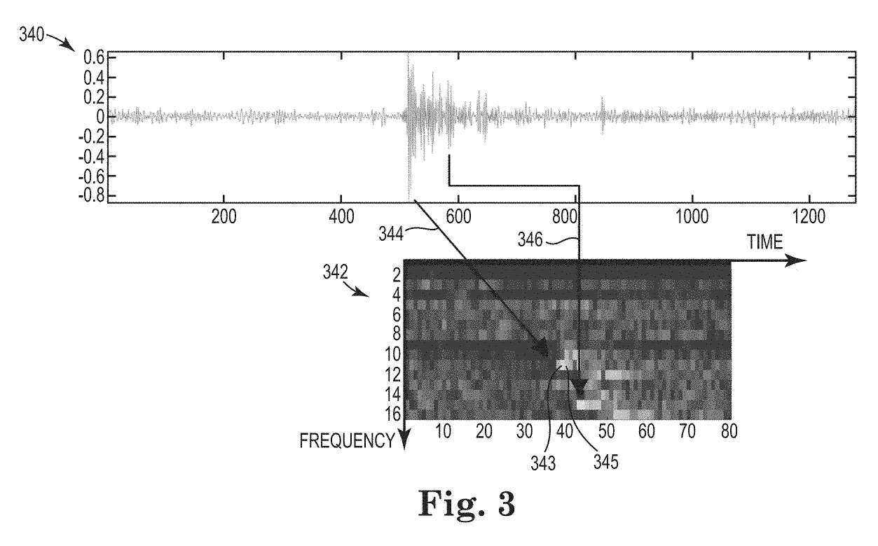

FIG. 3 is an example of a TF plane 342 corresponding to a trace 340. The trace 340 can be a trace of the marine seismic survey data 232 described in association with FIG. 2 above. An amplitude of a trace at a particular frequency and time can be represented by a TF atom having a particular shading or color that corresponds to the amplitude. For example, a trace having a higher amplitude at a first time and frequency than at a second time and frequency can be represented by a TF atom of a corresponding TF plane having a brighter shading at the first time and frequency than a TF atom of the TF plane at the second time and frequency where the trace has a lower amplitude. As illustrated in the TF plane 342, a first TF atom 343 having a first amplitude is shown with a brighter shading than that of a second TF atom 345 having a second amplitude that is less than the first amplitude. The TF atoms of the TF plane 342 correspond to integer values of time and frequency of the trace 340. The TF atoms to which arrows 344 and 346 point have a brighter shading corresponding to the high amplitude of the trace 340 from which the arrows 344 and 346 originate. The TF plane 342 includes a few TF atoms corresponding to a seismic signal. Thus, the seismic signal of the trace 340 has sparse representation in the TF plane 342. In the TF plane 342, TF atoms corresponding to a seismic signal have bright shading because the amplitude of a seismic signal is greater than the amplitude of noise. Because the barnacle noise in the trace 340 is broadband, the barnacle noise occupies multiple frequencies in the trace 340 whereas seismic signals in the trace 340 are localized to a few frequencies. Thus, in contrast to the few TF atoms corresponding to seismic signals, the TF plane 342 includes many TF atoms corresponding to broadband noise. As used herein, “broadband noise” refers to noise that occurs in a range of frequencies. As used herein, “spike noise” refers to noise having an amplitude at least an order of magnitude higher than an average amplitude of noise within a narrow range of times or a narrow range of frequencies. The broadband noise in the trace 340 does not have as high an amplitude as seismic signals. As such, the TF atoms corresponding to broadband noise in the trace 340 have darker shading than the TF atoms corresponding to seismic signals.

Referring back to FIG. 2, in at least one embodiment of the present disclosure, the first stage 236 can include applying a 1-D complex wavelet transform to a trace to generate a corresponding 2-D complex TF plane. Each TF coefficient of the 1-D complex wavelet TF transform from which a 2-D complex TF plane was generated can correspond to a wavelet atom in a TX domain. As used herein, “wavelet atom” refers to a pair of a time value and a space value of a trace and represents an amplitude of the trace at the time and space values. As used herein, a “TF coefficient” refers to a value of an element of a matrix resulting from applying a 1-D transform to a trace. TF coefficients can be information about a trace in both time and frequency. Each TF coefficient of a TF plane can correlate to a trace with a TF atom (or a wavelet). The TF atom (or wavelet) can be well localized in time and space.

The first stage 236 can include transforming traces of a shot gather into a three-dimensional (3-D) TF cube. Each TF plane corresponds to a respective one of the trace, where each trace corresponds to a respective receiver. For example, a streamer including one hundred receivers can have a corresponding one hundred traces, each trace being represented by a respective TF plane. Together the TF planes comprise a TF cube. The dimensions of the TF cube can be time, frequency, and offset. The offset of a TF plane of a TF cube can correspond to a respective position of a receiver. The offset can be a relative position of a receiver. For example, the offset can be a relative position of a receiver along a streamer. A shot gather can include marine seismic survey data of a plurality of traces corresponding to a plurality of receivers. Each TF plane can correspond to one of the traces and one of the receivers. Thus, a shot gather can be represented by a TF cube. In at least one embodiment of the present disclosure, a TF cube can be generated by applying a complex wavelet packet transform to traces of a shot gather. As used herein, a “complex wavelet packet transform” refers to a set of 1-D complex wavelet transforms.

The first stage 236 can include filtering through the TF cube using a 3-D window. The dimensions of the 3-D window can be time, frequency, and offset. A gather can have two dimensions: time and offset. Because the 1-D complex wavelet transform can represent a trace in time and frequency, the result of the 1-D complex wavelet transform on all traces of a gather is a time-frequency-offset cube. The 3-D window can filter through the TF cube trace by trace to attenuate noise signals in the shot gather on a trace-by-trace basis. If a TF atom of a trace corresponds to a noise signal in the trace, then the noise signal can be attenuated based on several parameters. A non-limiting example of such a parameter is amplitude values of other TF atoms within the 3-D window relative to the amplitude value of the TF atom in which noise is being denoised. Another non-limiting example of such a parameter is classification of one or more traces within the 3-D window as noisy or non-noisy. Another non-limiting example of such a parameter is the distance between a receiver that recorded a trace being denoised and one or more receivers that recorded traces classified as non-noisy. The parameters can change from trace to trace during the trace-based noise attenuation of the first stage 236. This enables the noise attenuation of the first stage 236 to be tailored to the noise signals of each trace of the marine seismic survey data 232.

The noise attenuation performed in the first stage 236 can attenuate both broadband noise and spike noise in a TF representation of a trace. The broadband noise can be attenuated by taking amplitude values of TF atoms of TF planes corresponding to non-noisy traces into account. The broadband noise can be attenuated using information obtained from classifying the traces of the marine seismic survey data 232 as noisy or non-noisy during the preprocessing stage 234. Amplitudes of TF atoms of a TF plane corresponding to a trace being denoised that are abnormally high relative to TF atoms of one or more TF planes corresponding to traces of neighboring receivers can be reduced to an amplitude of TF atoms representing similar times and frequencies in the traces of neighboring receivers. In at least one embodiment of the present disclosure, abnormally high amplitudes can be reduced using median filtering.

After filtering through the TF cube, the TF cube can be transformed back to the TX domain to yield a signal component and a noise component of the marine seismic survey data 232. The signal component includes primarily seismic signals. The signal component can be substantially noise-free and have approximately the same SNR in all traces without spike noise. The noise component includes primarily noise signals attenuated (removed) during the first stage 236. However, the noise component can also include a signal leakage component. As used herein, “signal leakage component” refers to seismic signals inadvertently attenuated (removed) during the first stage 236 and included in the noise component.

The signal component and the noise component from the first stage 236 of the multi-stage noise attenuation can be inputs of the second stage 238 of the multi-stage noise attenuation. After applying the trace-based (1-D) noise attenuation of the first stage 236, the second stage 238 can include attenuating signal leakage from the noise component from the first stage 236.

The second stage 238 can include bringing a signal leakage component back to the signal component from the noise component by applying a 2-D directional transform to the noise component. Examples of a 2-D directional transform include, but are not limited to, a directional filter bank (DFB), a curvelet transform, a 2-D anisotropic Gabor transform, and a Radon transform. In at least one embodiment of the present disclosure, the DFB can be a set of cone filters that cover a whole frequency plane. The DFB can be constructed in such a way that the DFB is self-invertible like other orthogonal or tight-frame discrete transforms. When the DFB is configured with an increasing number of directions, properties of the DFB can be similar to a linear Radon transform. In at least one embodiment of the present disclosure, a complex DFB can be used, which is shift invariant like the 1-D complex wavelet transform that can be used during the first stage 236.

Because the signal component can be substantially free of abnormal amplitude noise, the signal component in the DFB domain can be concentrated in a few dominant DFB coefficients. As used herein, “DFB coefficients” refer to values of elements of a matrix resulting from applying a 2-D directional transform to the noise component. Dominant DFB coefficients can correspond to seismic events at a particular location and direction. The signal component in the DFB domain can be used as a weighting mask to estimate the signal leakage component and bring the signal leakage component from the noise component back to the signal component by adding the estimated signal leakage component to the signal leakage component. At least one embodiment of the present disclosure can include using the weighting mask in adaptive thresholding of the noise component in both the DFB domain and a complex wavelet domain. As used herein, “adaptive thresholding” refers to attenuating noise under a threshold that is variable. The threshold can be a user-defined value, such as a threshold number of decibels. The adaptive thresholding can be used to detect a signal leakage component and bring the signal leakage component back to the signal component. Because the threshold can be a user-defined value, adaptive thresholding can provide user control of the tradeoff between reducing signal leakage at the cost of reducing noise attenuation and increasing noise attenuation at the cost of increasing signal leakage.

The signal leakage component and the signal component can be combined with the residual seismic data from the preprocessing stage 234 to yield denoised seismic data. This process may be referred to as “upsampling” because adding the signal component (and the signal leakage component) to the residual seismic data results in the full spectrum of frequencies associated with the seismic signals that were in the original marine seismic survey data. The signal leakage component, signal component, and residual seismic data can be used to generate a seismic image that is less noisy than those generated by some previous approaches. The seismic image can also include more coherent energy than seismic images generated by some previous denoising approaches.

Although FIG. 2 illustrates multi-stage noise attenuation including the preprocessing stage 234, at least one embodiment of the present disclosure includes the first stage 236 and the second stage 238 without the preprocessing stage 234.

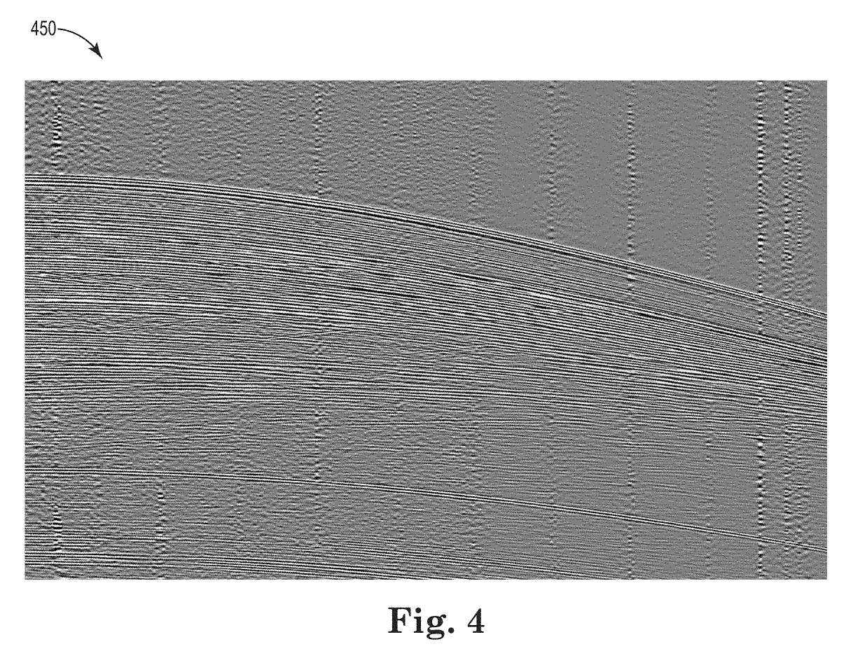

FIG. 4 is an example of marine seismic survey data 450 prior to multi-stage noise attenuation. The marine seismic survey data 450 can be analogous to the marine seismic survey data 232 illustrated in FIG. 2.

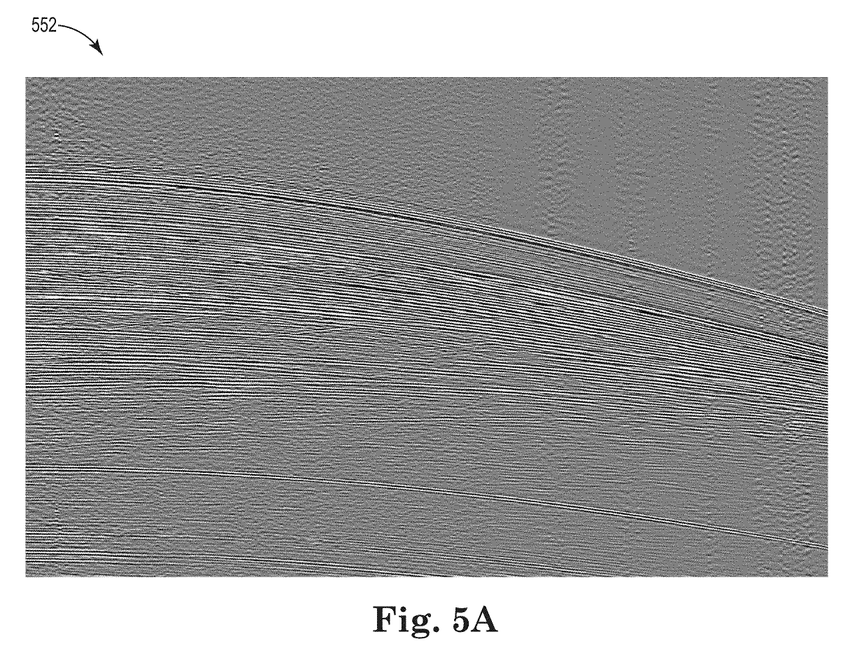

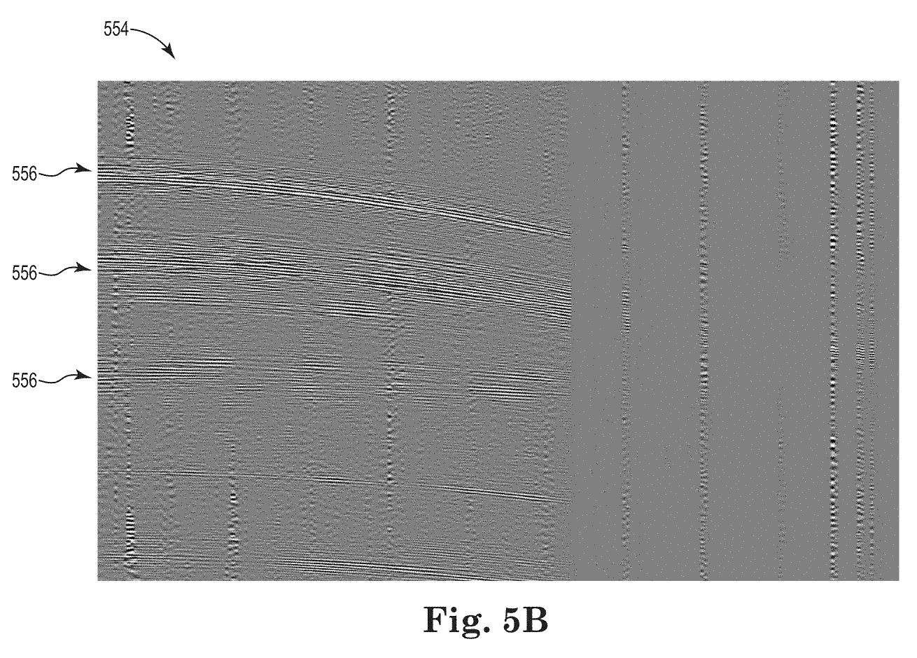

FIG. 5A is an example of a signal component 552 from a first stage of multi-stage noise attenuation. The first stage can be the first stage 236 described in association with FIG. 2 above. The signal component 552 has approximately the same SNR in approximately all traces. As demonstrated by a comparison of the signal component 552 to the marine seismic survey data 450 illustrated in FIG. 4, the signal component 552 is free of spike noise as a result of the trace-based noise attenuation of the first stage.

FIG. 5B is an example of a noise component 554 from the first stage of the multi-stage noise attenuation. The noise component 554 includes broadband noise and spike noise. The noise component 554 includes a signal leakage component as indicated by the arrows 556. As explained above, a second stage of multi-stage noise attenuation can include detecting a location and direction of the signal leakage component so that the signal leakage component can be brought back to the signal component 552 illustrated in FIG. 5A. As used herein, “location and direction of a signal leakage component” refer to a set of DFB coefficients. Because the noise attenuation performed during the first stage can generate a substantially noise-free seismic image, in the DFB domain the seismic image can be transformed to a set of dominant DFB coefficients. The second stage of the multi-stage noise attenuation can use an index of the set of DFB coefficients within a matrix (for example, location and direction) in recovering a signal leakage component in the noise component 554.

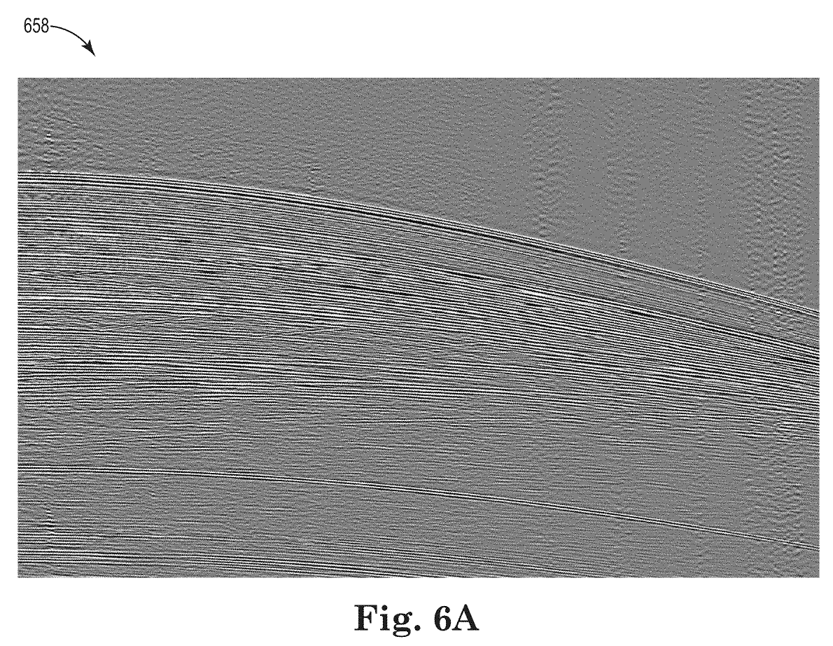

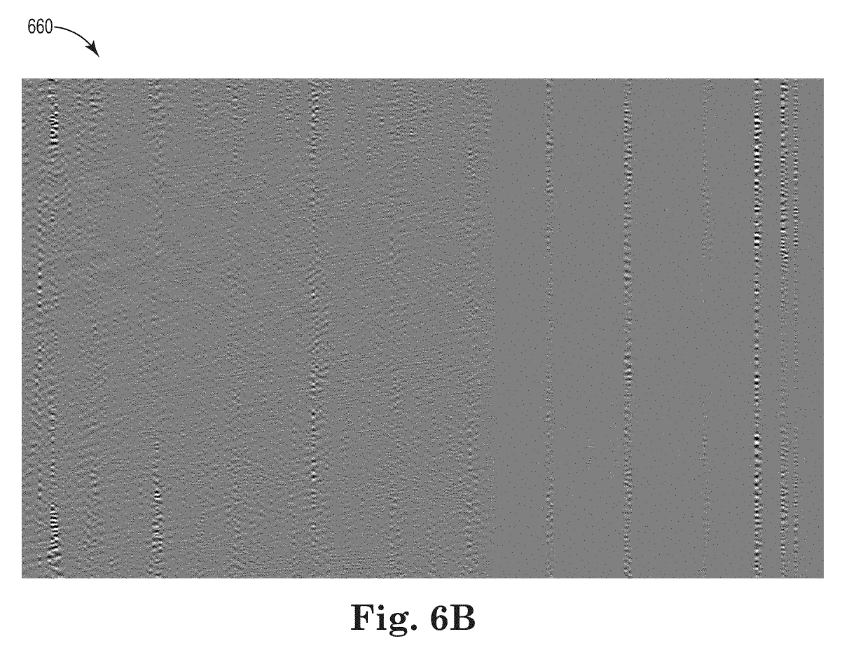

FIG. 6A is an example of an improved signal component 658 having a signal leakage component added thereto following a second stage of the multi-stage noise attenuation. The second stage can be the second stage 238 described in association with FIG. 2 above. The improved signal component 658 comprises the signal component 552 illustrated in FIG. 5A and an estimate of the signal leakage component in the noise component 554 illustrated in FIG. 5B. The signal leakage component in the noise component 554 can be combined with the signal component 552 to yield the improved signal component 658. A comparison of the signal component 552 to the improved signal component 658 shows that the second stage of the multi-stage noise attenuation results in the seismic signals of the marine seismic survey data 450 illustrated in FIG. 4 being reestablished.

FIG. 6B is an example of an updated noise component 660 having a signal leakage component attenuated therefrom following the second stage of the multi-stage noise attenuation. The updated noise component 660 comprises the noise component 554 illustrated in FIG. 5B with an estimate of the signal leakage component illustrated in FIG. 5B subtracted therefrom. A comparison of the noise component 554 to the updated noise component 660 shows that the second stage of the multi-stage noise attenuation results in a significant attenuation of the signal leakage component in the noise component 554 from the updated noise component 660.

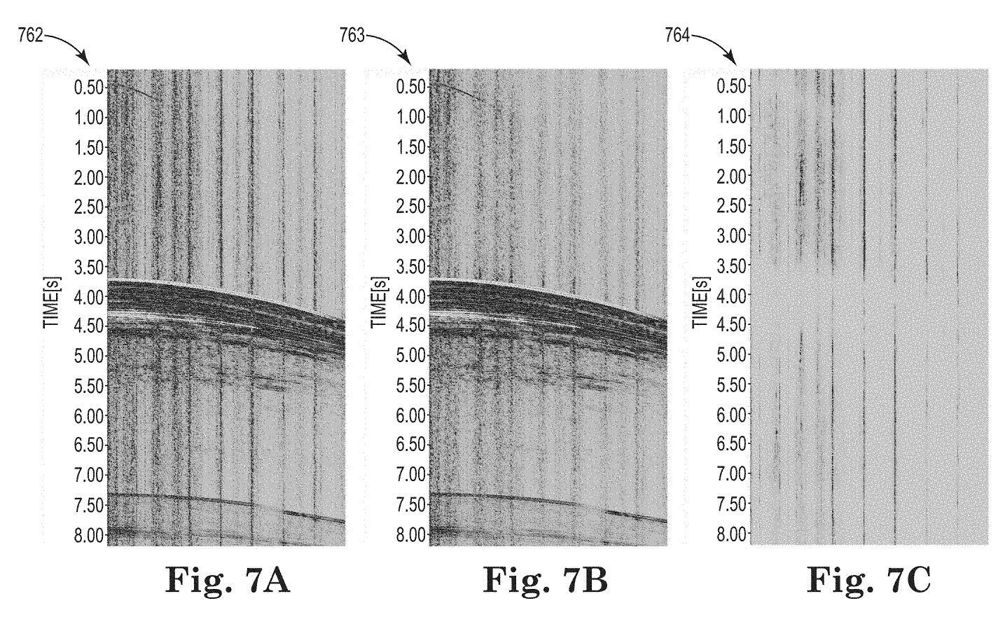

FIG. 7A is an example of marine seismic survey data 762 from an outer streamer of a marine seismic survey in a deep water environment. The marine seismic survey data 762 is sampled at two milliseconds in the temporal dimension and 12.5 meters in the offset dimension. A low-cut filter has been applied to the marine seismic survey data 762 between ten and sixteen Hz due to a poor SNR below ten Hz. FIG. 7A illustrates a geosensor shot gather before multi-stage noise attenuation. The marine seismic survey data 762 includes seismic signals and noise signals corresponding to barnacle noise.

FIG. 7B is an example of denoised marine seismic survey data 763 after multi-stage noise attenuation. In the denoised marine seismic survey data 763, the level of noise signals corresponding to barnacle noise in the marine seismic survey data 762 has been attenuated in several groups of traces, yielding a cleaner shot gather.

FIG. 7C is an example of a noise component 764 in the marine seismic survey data 762 obtained from multi-stage noise attenuation. In the noise component 764, the seismic signals of the marine seismic survey data 763 are excluded, including the direct wave, thereby preserving the seismic signals in the marine seismic survey data 763.

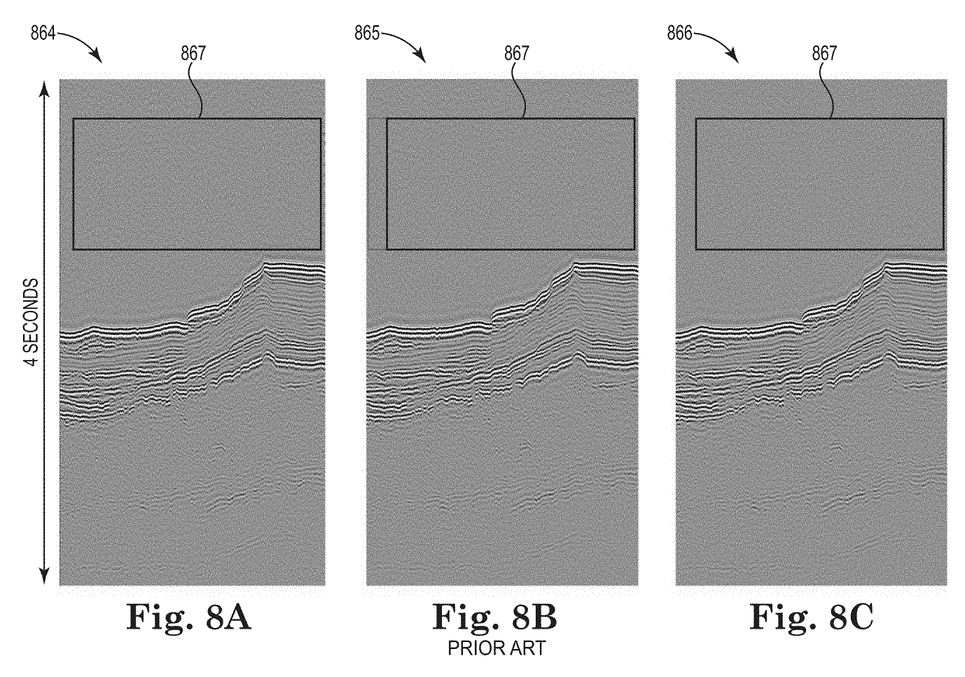

FIG. 8A is an example of a stack 864 of velocity sensor shot gathers. The stack 864 includes three thousand velocity sensor shot gathers computed from marine seismic survey data before multi-stage noise attenuation. The box 867 represents a one-second long time window in which there are no seismic signals (in the water column).

FIG. 8B is an example of a stack 865 of velocity sensor shot gathers after a previous approach to noise attenuation. In FIG. 8B, FX-Decon has been applied to the marine seismic survey data from which the stack 865 was computed. However, embodiments are not limited to using FX-Decon. For example, at least one embodiment can apply a predictive filter to marine seismic survey data in a frequency-offset domain. The box 867 represents a one-second long time window in which there are no seismic signals (in the water column).

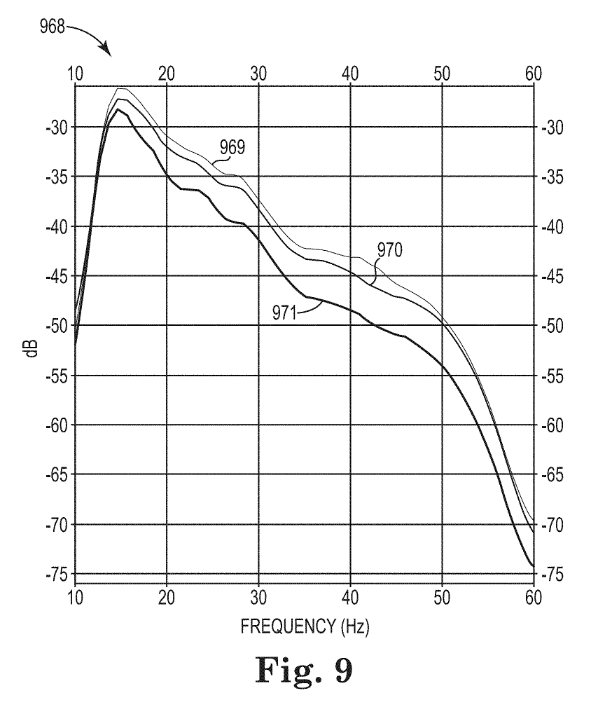

FIG. 8C is an example of a stack 866 of velocity sensor shot gathers after multi-stage noise attenuation according to at least one embodiment of the present disclosure. The box 867 represents a one-second long time window in which there are no seismic signals (in the water column). A difference between the stack 866 shown in FIG. 8C and the stack 865 shown in FIG. 8B is explained with association to FIG. 9 below.

FIG. 9 is a graph 968 illustrating spectral comparisons. The graph 968 includes amplitude spectra within the frequency range of ten and sixty Hz. The line 969 is the amplitude spectrum in the one-second long time window in which there are no seismic signals (the box 867) of the stack 864 illustrated in FIG. 8A. The line 970 is the amplitude spectrum in the one-second long time window in which there are no seismic signals (the box 867) of the stack 865 illustrated in FIG. 8B. The line 971 is the amplitude spectrum in the one-second long “signal-free” time window (the box 867) of the stack 866 illustrated in FIG. 8C. Because the amplitude spectra are in the one-second long time window in which there are no seismic signals, the amplitude can be attributed to noise signals as opposed to seismic signals. Note that the multi-stage noise attenuation of the present disclosure reduces the noise signals by one to four more decibels (dB) (compare the line 969 to the line 971) than FX-Decon (compare the line 969 to the line 978), all the way to sixty Hz.

FIG. 10 is an exemplary embodiment of a method 1072 for multi-stage noise attenuation. In at least one embodiment, the method 1072 can be performed by a machine, such as the machine 1392 described in association with FIG. 13 below. At 1073, the method 1072 can include attenuating noise signals on a trace-by-trace basis from a plurality of traces comprising the marine seismic survey data to yield a signal component and a noise component. As used herein, “a plurality of traces comprising the marine seismic survey data” can refer to all the traces of the marine seismic survey data or fewer than all the traces of the marine seismic survey data. A SNR variance of a plurality of traces comprising the signal component can be less than an SNR variance of the plurality of traces comprising the marine seismic survey data. As used herein, “a plurality of traces comprising the signal component” can refer to all the traces of the signal component or fewer than all the traces of the signal component. In at least one embodiment, noise signals are attenuated only in traces that have an SNR below a threshold SNR. Attenuating the noise signals can include applying a 1-D TF transform to the plurality of traces comprising the marine seismic survey data.

At 1074, the method 1072 can include attenuating signal leakage from the noise component to yield a signal leakage component. For example, the attenuation can include applying a 2-D directional TF transform to the signal component.

At 1099, the method 1072 can include generating a seismic image of a subsurface location based on the signal component and the signal leakage component. Generating the seismic image can include generating the seismic image based on the signal component, the signal leakage component, and residual seismic data.

Although not illustrated in FIG. 10, in at least one embodiment, the method 1072 can include, prior to attenuating the noise signals, transforming the marine seismic survey data to a frequency domain to yield noisy seismic data and residual seismic data. Attenuating the noise signals can include attenuating noise signals in the noisy seismic data to yield the signal component and the noise component. Transforming the marine seismic survey data to the frequency domain can include filtering portions of the marine seismic survey data that exceed a threshold frequency to yield the residual seismic data. Although not illustrated in FIG. 10, in at least one embodiment, the method 1072 can include receiving a definition of the threshold frequency based on a type of noise to be attenuated.

FIG. 11 is an exemplary embodiment of a machine-readable medium 1198 for multi-stage noise attenuation. The machine-readable medium 1198 can store instructions 1175, such as machine-readable instructions. The instructions 1175 can be program instructions executable to implement a particular function. For example, the instructions 1175 can be executed to identify noisy traces and non-noisy traces of the marine seismic survey data based on a threshold SNR as shown at block 1176. The instructions 1175 can be executed to transform the noisy traces to a TF cube by a complex wavelet packet transform as shown at block 1177. The instructions to transform the noisy traces to the TF cube can include instructions to represent each of the noisy traces as a respective 2-D TF plane of the TF cube. The instructions 1175 can be executed to reduce broadband noise and spike noise from each TF atom of one of the noisy traces based on information of neighboring TF atoms in the TF cube as shown at block 1178. The instructions 1175 can be executed to reduce the broadband noise based on a level of the non-noisy traces. The instructions 1175 can be executed to reduce the spike noise can include instructions to median filter the spike noise from the TF atom.

The instructions 1175 can be executed to transform the denoised TF cube back to a TX domain to yield a signal component and a noise component as shown at block 1179. The instructions 1175 can be executed to transform the signal component into a DFB domain as shown at block 1181. The instructions 1175 can be executed to estimate a signal leakage component from each of the transformed signal component by an adaptive thresholding using weighting masks in the DFB domain and a complex wavelet packet domain as shown at block 1182. The instructions 1175 can be executed to generate a seismic image based on the signal leakage component and the signal component as shown at block 1183.

Although not illustrated in FIG. 11, the instructions 1175 can be executed to filter through the TF cube with a three-dimensional window. The instructions 1175 can be executed to reduce the broadband noise and the spike noise based on at least one of the values of other TF atoms within the 3-D window, classification of traces within the 3-D window as noisy or non-noisy, and a distance between one of the noisy traces to one of the non-noisy traces. The instructions 1175 can be executed to receive the threshold SNR as a user-defined value. The instructions 1175 can be executed combine the signal leakage component and the signal component with the non-noisy traces.

FIG. 12 is a diagram illustrating an exemplary embodiment of a system 1284 for multi-stage noise attenuation. The system 1284 can include a database 1285, a subsystem 1287, and/or a number of engines, such as a preprocessing engine 1288, a trace-based noise attenuation engine 1289, and a signal leakage attenuation engine 1290. The subsystem 1287 can be analogous to the controller 119 illustrated in FIG. 1 in at least one embodiment. However, embodiments of the present disclosure are not limited to being performed onboard a marine survey vessel. For example, at least one embodiment can be performed by the system 1284 onshore. The subsystem 1287 and engines can be in communication with the database 1285 via a communication link. The database 1285 can store seismic data sets 1286. The seismic data sets 1286 can include marine seismic survey data, among other seismic data sets.

The system 1284 can include more or fewer engines than illustrated to perform the various functions described herein. The system 1284 can represent program instructions and/or hardware of a machine such as the machine 1392 referenced in FIG. 13, etc. As used herein, an “engine” can include program instructions and/or hardware, but at least includes hardware. Hardware is a physical component of a machine that enables it to perform a function. Examples of hardware can include a processing resource, a memory resource, a logic gate, etc.

The number of engines can include a combination of hardware and program instructions that is configured to perform a number of functions described herein. The program instructions, such as software, firmware, etc., can be stored in a memory resource such as a machine-readable medium, etc., as well as hard-wired program such as logic. Hard-wired program instructions can be considered as both program instructions and hardware.

The preprocessing engine 1288 can include a combination of hardware and program instructions that is configured to identify noisy traces in marine seismic survey data. The preprocessing engine 1288 can be configured to receive the marine seismic survey data.

The trace-based noise attenuation engine 1289 can include a combination of hardware and program instructions that is configured to transform the identified noisy traces into a time-frequency-offset cube, attenuate noise in a TF atom of the time-frequency-offset cube based on information associated with neighboring TF atoms of the time-frequency-offset cube to denoise the time-frequency-offset cube, and transform the denoised time-frequency-offset cube back to a TX domain to yield a signal component of the marine seismic survey data and a noise component of the marine seismic survey data. The trace-based noise attenuation engine 1289 can be configured to transform the identified noisy traces into the time-frequency-offset cube using a complex wavelet transform.

The signal leakage attenuation engine 1290 can include a combination of hardware and program instructions that is configured to decompose the signal component using a TF directional transform, estimate a signal leakage component from the decomposed signal component, and combine the estimated signal leakage component with the signal component to yield denoised marine seismic survey data. The signal leakage attenuation engine 1290 can be configured to use the signal component as a weighting mask in a domain associated with the TF directional transform to estimate the signal leakage component. The TF directional transform can be a directional filter bank (DFB). The weighting mask can use an adaptive thresholding of the noise component in a DFB domain and a complex wavelet packet domain.

FIG. 13 is a diagram of an exemplary embodiment of a machine 1392 for multi-stage noise attenuation. The machine 1392 can utilize software, hardware, firmware, and/or logic to perform a number of functions. The machine 1392 can be a combination of hardware and program instructions configured to perform a number of functions and/or actions. The hardware, for example, can include a number of processing resources 1391 and a number of memory resources 1393, such as a machine-readable medium or other non-transitory memory resources 1393. The memory resources 1393 can be internal and/or external to the machine 1392, for example, the machine 1392 can include internal memory resources and have access to external memory resources. The program instructions, such as machine-readable instructions, can include instructions stored on the machine-readable medium to implement a particular function. The set of machine-readable instructions can be executable by one or more of the processing resources 1391. The memory resources 1393 can be coupled to the machine 1392 in a wired and/or wireless manner. For example, the memory resources 1393 can be an internal memory, a portable memory, a portable disk, and/or a memory associated with another resource, for example, enabling machine-readable instructions to be transferred and/or executed across a network such as the Internet. As used herein, a “module” can include program instructions and/or hardware, but at least includes program instructions.

The memory resources 1393 can be non-transitory and can include volatile and/or non-volatile memory. Volatile memory can include memory that depends upon power to store data, such as various types of dynamic random-access memory among others. Non-volatile memory can include memory that does not depend upon power to store data. Examples of non-volatile memory can include solid state media such as flash memory, electrically erasable programmable read-only memory, phase change random access memory, magnetic memory, optical memory, and/or a solid-state drive, etc., as well as other types of non-transitory machine-readable media.

The processing resources 1391 can be coupled to the memory resources 1393 via a communication path 1394. The communication path 1394 can be local or remote to the machine 1392. Examples of a local communication path 1394 can include an electronic bus internal to a machine, where the memory resources 1393 are in communication with the processing resources 1391 via the electronic bus. Examples of such electronic buses can include Industry Standard Architecture, Peripheral Component Interconnect, Advanced Technology Attachment, Small Computer System Interface, Universal Serial Bus, among other types of electronic buses and variants thereof. The communication path 1394 can be such that the memory resources 1393 are remote from the processing resources 1391, such as in a network connection between the memory resources 1393 and the processing resources 1391. That is, the communication path 1394 can be a network connection. Examples of such a network connection can include a local area network, wide area network, personal area network, and the Internet, among others.

As shown in FIG. 13, the machine-readable instructions stored in the memory resource 1393 can be segmented into a number of modules, such as the preprocessing module 1395, the trace-based noise attenuation module 1396, and the signal leakage attenuation module 1397, that when executed by the processing resource 1391 can perform a number of functions. As used herein, a module includes a set of instructions included to perform a particular task or action. The number of modules can be sub-modules of other modules. For example, the signal leakage attenuation module 1397 can be a sub-module of the trace-based noise attenuation module 1396. Furthermore, the number of modules can comprise individual modules separate and distinct from one another. Examples are not limited to the specific modules 1395, 1396, and 1397 illustrated in FIG. 13.

Each of the number of modules can include program instructions and/or a combination of hardware and program instructions that, when executed by the processing resources 1391, can function as a corresponding engine as described in association with FIG. 12 above. For example, the preprocessing module 1395 can include program instructions and/or a combination of hardware and program instructions that, when executed by the processing resources 1391, can function as the preprocessing engine 1288. The trace-based noise attenuation module 1396 can include program instructions and/or a combination of hardware and program instructions that, when executed by the processing resources 1391, can function as the trace-based noise attenuation engine 1289. The signal leakage attenuation module 1397 can include program instructions and/or a combination of hardware and program instructions that, when executed by the processing resources 1391, can function as the trace-based noise attenuation engine 1290.

In accordance with at least one embodiment of the present disclosure, a geophysical data product may be produced or manufactured. Noise signals can be attenuated on a trace-by-trace basis from a plurality of traces comprising the marine seismic survey data to yield a signal component and a noise component. A difference in signal-to-noise ratio (SNR) between a plurality of traces of the signal component can be less than a difference in SNR between the plurality of traces comprising the marine seismic survey data. Signal leakage can be attenuated from the noise component to yield a signal leakage component. In at least one embodiment, the signal component and the signal leakage component can be recorded in a tangible machine-readable medium thereby completing the manufacture of the geophysical data product.

At least one embodiment of the present disclosure can include attenuating incoherent noise signals on a trace-by-trace basis from the marine seismic survey data to yield denoised marine seismic survey data and attenuating signal leakage from attenuating the incoherent noise signals using information of seismic signals in the denoised marine seismic survey data, wherein the improvement comprises a user control of tradeoffs of attenuating the incoherent noise signals and attenuating the signal leakage.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method of multi-stage noise attenuation for marine seismic survey data, comprising:
attenuating noise signals on a trace-by-trace basis from a plurality of traces comprising the marine seismic survey data to yield a signal component and a noise component;
wherein a signal-to-noise ratio (SNR) variance of a plurality of traces comprising the signal component is less than an SNR variance of the plurality of traces comprising the marine seismic survey data;
attenuating signal leakage from the noise component to yield a signal leakage component; and
generating a seismic image of a subsurface location based on the signal component and the signal leakage component.

2. The method of claim 1, wherein attenuating the noise signals comprises attenuating signals only in traces that have an SNR below a threshold SNR.

3. The method of claim 1, further comprising:
prior to attenuating the noise signals, transforming the marine seismic survey data to a frequency domain to yield noisy seismic data and residual seismic data; and
wherein attenuating the noise signals comprises attenuating noise signals in the noisy seismic data to yield the signal component and the noise component.

4. The method of claim 3, wherein transforming the marine seismic survey data to the frequency domain comprises filtering portions of the marine seismic survey data that exceed a threshold frequency to yield the residual seismic data.

5. The method of claim 4, further comprising receiving a definition of the threshold frequency based on a type of noise to be attenuated.

6. The method of claim 3, wherein generating the seismic image comprises generating the seismic image based on the signal component, the signal leakage component, and the residual seismic data.

7. The method of claim 1, wherein attenuating the noise signals comprises applying a one-dimensional (1-D) time-frequency (TF) transform to the plurality of traces comprising the marine seismic survey data.

8. The method of claim 1, wherein attenuating the signal leakage component comprises applying a two-dimensional (2-D) directional time-frequency (TF) transform to the signal component.

9. A system for multi-stage noise attenuation for marine seismic survey data, comprising:
a preprocessing engine configured to identify noisy traces in the marine seismic survey data;
a trace-based noise attenuation engine configured to:
transform the identified noisy traces into a time-frequency-offset cube;
attenuate noise in a time-frequency (TF) atom of the time-frequency-offset cube based on information associated with neighboring TF atoms of the time-frequency-offset cube to denoise the time-frequency-offset cube; and
transform the denoised time-frequency-offset cube back to a time-space (TX) domain to yield a signal component of the marine seismic survey data and a noise component of the marine seismic survey data; and
a signal leakage attenuation engine configured to:
decompose the signal component using a TF directional transform;
estimate a signal leakage component from the decomposed signal component; and
combine the estimated signal leakage component with the signal component to yield denoised marine seismic survey data.

10. The system of claim 9, wherein the signal leakage attenuation engine is configured to use the signal component as a weighting mask in a domain associated with the TF directional transform to estimate the signal leakage component.

11. The system of claim 10, wherein:
the TF directional transform is a directional filter bank (DFB); and
the weighting mask uses an adaptive thresholding of the noise component in a DFB domain and a complex wavelet packet domain.

12. The system of claim 9, wherein the trace-based noise attenuation engine is configured to transform the identified noisy traces into the time-frequency-offset cube using a complex wavelet transform.

13. The system of claim 9, wherein the preprocessing engine is configured to receive the marine seismic survey data.

14. A non-transitory machine-readable medium storing a set of instructions executable by a processing resource to:
identify noisy traces and non-noisy traces of marine seismic survey data based on a threshold signal-to-noise ratio (SNR);
transform the noisy traces to a TF cube by a complex wavelet packet transform;
reduce broadband noise and spike noise from each TF atom of the noisy traces based on information of neighboring TF atoms in the TF cube;
transform the denoised TF cube back to a time-space (TX) domain to yield a signal component and a noise component;
transform the signal component into a directional filter bank (DFB) domain;
estimate a signal leakage component from the transformed signal component by an adaptive thresholding using weighting masks in the DFB domain and a complex wavelet packet domain; and
generate a seismic image based on the signal leakage component and the signal component.

15. The medium of claim 14, wherein the instructions to transform the noisy traces to the TF cube comprise instructions to represent each of the noisy traces as a respective two-dimensional (2-D) TF plane of the TF cube.

16. The medium of claim 14, further comprising instructions to filter through the TF cube with a three-dimensional (3-D) window.

17. The medium of claim 16, further comprising instructions to reduce the broadband noise and the spike noise based on at least one of:
values of other TF atoms within the 3-D window;
classification of traces within the 3-D window as noisy or non-noisy; and
a distance between one of the noisy traces to one of the non-noisy traces.

18. The medium of claim 14, wherein the instructions to reduce the broadband noise comprise instructions to reduce the broadband noise based on a level of the non-noisy traces.

19. The medium of claim 14, wherein the instructions to reduce the spike noise comprise instructions to median filter the spike noise from the TF atom.

20. The medium of claim 14, further comprising instructions to receive the threshold SNR as a user-defined value.

21. The medium of claim 14, further comprising instructions to combine the signal leakage component and the signal component with the non-noisy traces.

22. A method to manufacture a geophysical data product, comprising:
attenuating noise signals on a trace-by-trace basis from a plurality of traces comprising the marine seismic survey data to yield a signal component and a noise component;
wherein a signal-to-noise ratio (SNR) variance of a plurality of traces comprising the signal component is less than an SNR variance of the plurality of traces comprising the marine seismic survey data;
attenuating signal leakage from the noise component to yield a signal leakage component; and
recording the signal component and the signal leakage component in a tangible machine-readable medium thereby completing the manufacture of the geophysical data product.
